(19) United States
(12) Patent Application Publication
(10) Pub. No.: US 2025/0095660 A1
(43) Pub. Date: Mar. 20, 2025

(54) SPATIAL CODING OF HIGHER ORDER AMBISONICS FOR A LOW LATENCY IMMERSIVE AUDIO CODEC

(71) Applicants: Dolby Laboratories Licensing Corporation, San Francisco, CA (US); DOLBY INTERNATIONAL AB, Dublin (IE)

(72) Inventors: Stefanie BROWN, Lewisham (AU); Stefan BRUHN, Sollentuna (SE); Rishabh TYAGI, Sydney (AU)

(73) Assignees: Dolby Laboratories Licensing Corporation, San Francisco, CA (US); DOLBY INTERNATIONAL AB, Dublin (IE)

(21) Appl. No.: 18/729,248

(22) PCT Filed: Jan. 9, 2023
(86) PCT No.: PCT/US2023/010415

§ 371 Date: Jul. 16, 2024

Related U.S. Application Data
(60) Provisional application No. 63/301,152, filed on Jan. 20, 2022.
(60) Provisional application No. 63/394,586, filed on Aug. 2, 2022.
(60) Provisional application No. 63/476,518, filed on Dec. 21, 2022.

(51) Int. Cl. G10L 19/008; G10L 19/002; G10L 19/02; G10L 19/025; G10L 19/032; G10L 19/06

(52) U.S. Cl. CPC G10L 19/008; G10L 19/002; G10L 19/0204; G10L 19/025; G10L 19/032; G10L 19/06

(57) ABSTRACT

Described herein is a method of encoding Higher Order Ambisonics, HOA, audio, the method including: receiving an input HOA audio signal having more than four Ambisonics channels; encoding the HOA audio signal using a SPAR coding framework and a core audio encoder; and providing the encoded HOA audio signal to a downstream device, the encoded HOA audio signal including core encoded SPAR downmix channels and encoded SPAR metadata. Further described are a method of decoding Higher Order Ambisonics, HOA, audio, respective apparatuses and computer program products.

### CROSS-REFERENCE TO RELATED APPLICATIONS

This application claims priority to U.S. Provisional Patent Application No. 63/301,152 filed Jan. 20, 2022, U.S. Provisional Patent Application No. 63/394,586 filed Aug. 2, 2022, and U.S. Provisional Patent Application No. 63/476,518 filed Dec. 21, 2022, each of which are hereby incorporated by reference in their entireties.

### TECHNICAL FIELD

The present disclosure generally relates to a method of encoding Higher Order Ambisonics (HOA) audio. In particular, the method includes encoding the HOA audio signal using a Spatial Reconstruction (SPAR) coding framework and a core audio encoder. The present disclosure relates further to a method of decoding HOA audio, respective apparatuses, and computer program products.

While some embodiments will be described herein with particular reference to that disclosure, it will be appreciated that the present disclosure is not limited to such a field of use and is applicable in broader contexts.

### BACKGROUND

Any discussion of the background art throughout the disclosure should in no way be considered as an admission that such art is widely known or forms part of common general knowledge in the field.

SPAR is a technology to spatially code Ambisonics and is used in the Immersive Voice and Audio Services (IVAS) codec to be standardized by the 3^{rd} Generation Partnership Project (3GPP). Up to now, the SPAR coding framework has been applied with regard to First Order Ambisonics (FOA), across a range of bitrates. There is, however, still an existing need to expand the SPAR algorithm to Higher Order Ambisonics, in particular, to enhance the algorithm to achieve good results within the IVAS framework.

### SUMMARY

In accordance with a first aspect of the present disclosure there is provided a method of encoding Higher Order Ambisonics, HOA, audio. The method may include receiving an input HOA audio signal having more than four Ambisonics channels. The method may further include encoding the HOA audio signal using a SPAR coding framework and a core audio encoder. And the method may include providing the encoded HOA audio signal to a downstream device, the encoded HOA audio signal including core encoded SPAR downmix channels and encoded SPAR metadata.

In some embodiments, the encoding may include: generating, based on some or all of the Ambisonics channels, a representation of a W channel and a set of nₜₒₜₐₗ prediction residuals along with computing in SPAR metadata respective prediction coefficients; and selecting, out of the set of nₜₒₜₐₗ prediction residuals, a subset of nm prediction residuals to be directly coded to obtain a number of n_{dmx}=nᵣₑₛ+1 downmix channels (+1 referring to the inclusion of the representation of the W channel) to be provided to the downstream device.

In some embodiments, the selection of the subset of nᵣₑₛ prediction residuals may be based on a threshold number for directly coded channels indicating a maximum number of directly coded channels.

In some embodiments, the threshold number for directly coded channels may be determined based on information indicative of one or more of a bitrate limitation, a metadata size, a core codec performance, and an audio quality.

In some embodiments, the threshold number for directly coded channels may be chosen from a predetermined set of threshold numbers for directly coded channels.

In some embodiments, the subset of nᵣₑₛ prediction residuals may be selected in accordance with a channel ranking of the Ambisonics channels starting from high-ranked to low-ranked channels.

In some embodiments, the channel ranking of the Ambisonics channels may be based on a perceptual importance of the Ambisonics channels, with Ambisonics channels being higher in the channel ranking having higher perceptual importance.

In some embodiments, the channel ranking of the Ambisonics channels may be based on a channel ranking agreement between encoder and decoder.

In some embodiments, Ambisonics channels corresponding to a spherical harmonic Yₗ^{m}(θ, φ) with larger overlap with a left-right-front-rear plane may be ranked to be perceptually more important than Ambisonics channels corresponding to a spherical harmonic Yₗ^{m}(θ, φ) with larger overlap with a height direction, for a given order l.

In some embodiments, Ambisonics channels corresponding to a spherical harmonic Yₗ^{m}(θ, φ) with larger overlap with a left-right direction may be ranked to have higher perceptual importance than Ambisonics channels corresponding to a spherical harmonic Yₗ^{m}(θ, φ) with larger overlap with a front-rear direction.

In some embodiments, pairs formed by Ambisonics channels corresponding to spherical harmonics Yₗ^{m}(θ, φ) for a given order l with |m|=l may be ranked to be perceptually more important than HOA channels for the given order l with |m|<l.

In some embodiments, the channel ranking of the Ambisonics channels corresponding to spherical harmonics Yₗ^{m}(θ, φ) of a given order l may form a subset of the channel ranking of the Ambisonics channels corresponding to spherical harmonics Yₗ₊₁^{m}(θ, φ) of an (l+1)-th order, the channel ranking of the Ambisonics channels of the (l+1)-th order may start with the channel ranking of the Ambisonics channels of the l^{th} order.

In some embodiments, Ambisonics channels corresponding to a spherical harmonic Yₗ^{m}(θ, φ) with larger overlap in the left-right-front-rear plane of a given order l may be ranked to have higher perceptual importance than Ambisonics channels corresponding to a spherical harmonic Yₗ₋₁^{m}(θ, φ) of an (l−1)-th order with larger overlap in the height direction.

In some embodiments, one or more prediction residuals to be subsequently added to the subset of nᵣₑₛ prediction residuals may be selected based on a ranking promoting Ambisonics channels corresponding to a spherical harmonic Yₗ^{±l}(θ, φ) over Ambisonics channels corresponding to a spherical harmonic Yₗ^{θ}(θ, φ) ahead of Ambisonics channels corresponding to a spherical harmonic Yₗ^{m}(θ, φ), where 0<|m|<l.

In some embodiments, the encoding may further include representing parametric channels based on computing in SPAR metadata respective coefficients from the remaining n_{dec}=nₜₒₜₐₗ−nᵣₑₛ prediction residuals.

In some embodiments, the computing in SPAR metadata may include computing a plurality of cross-prediction coefficients for use by a decoder to reconstruct at least part of the n_{dec} parametric channels from the nᵣₑₛ directly coded prediction residuals.

In some embodiments, the computing in SPAR metadata may further include computing a plurality of decorrelator coefficients for use by the decoder to account, during reconstruction, for remaining energy not accounted for by the prediction coefficients and the cross-prediction coefficients.

In some embodiments, the computing in SPAR metadata may further include computing at least one of the prediction coefficients, the cross-prediction coefficients and the decorrelator coefficients with a first time resolution of t₁ milliseconds which is larger than a second time resolution of t₂ milliseconds of an encoder filterbank.

In some embodiments, the computing with the second time resolution of t₂ milliseconds may only be performed for high frequency bands.

In some embodiments, the computing with the second time resolution of t₂ milliseconds may be performed upon detection of a transient.

In some embodiments, the computing in SPAR metadata may further include computing a normalization term for channels corresponding to a given Ambisonics order l, by using only covariance estimates of channels corresponding to the order l.

In some embodiments, the encoding may further include obtaining a bitrate limitation value, selecting, out of a set of SPAR quantization modes, a SPAR quantization mode to meet the bitrate limitation value and applying the selected SPAR quantization mode to the SPAR metadata.

In some embodiments, some or all of the modes in the set of SPAR quantization modes may include re-allocating bits to coefficients relating to Ambisonics channels being ranked higher in the channel ranking from coefficients relating to Ambisonics channels being ranked lower in the channel ranking.

In some embodiments, some or all of the modes in the set of SPAR quantization modes may include selecting a subset of cross-prediction coefficients to be omitted from the plurality of cross-prediction coefficients.

In some embodiments, some or all of the modes in the set of SPAR quantization modes may include selecting a subset of decorrelator coefficients to be omitted from the plurality of decorrelator coefficients.

In some embodiments, selecting the subset of coefficients may be based on the channel ranking of the Ambisonics channels.

In some embodiments, the received input HOA audio signal may consist of Ambisonics channels that are ranked to have a relatively high perceptual importance.

In accordance with a second aspect of the present disclosure there is provided a method of decoding Higher Order Ambisonics, HOA, audio. The method may include receiving an encoded HOA audio signal, the encoded HOA audio signal having been obtained by applying a SPAR coding framework and a core audio encoder to an input HOA audio signal having more than four Ambisonics channels. The method may further include decoding the encoded HOA audio signal to obtain a decoded HOA audio signal, the decoded HOA audio signal including core decoded SPAR downmix channels and decoded SPAR metadata. And the method may include reconstructing the input HOA audio signal based on the decoded HOA audio signal to obtain, as an output HOA signal, a reconstructed input HOA audio signal.

In some embodiments, the core decoded SPAR downmix channels may include a representation of a W channel and a set of nm directly coded prediction residuals, and the decoded SPAR metadata may include a plurality of prediction coefficients, a plurality of cross-prediction coefficients, and a plurality of decorrelator coefficients.

In some embodiments, reconstructing the input HOA audio signal may include predicting a subset of the Ambisonics channels of the HOA audio signal based on the representation of the W channel and the plurality of prediction coefficients and adding in the set of nᵣₑₛ directly coded prediction residuals.

In some embodiments, reconstructing the input HOA audio signal may further include determining remaining parametric channels based on the representation of the W channel, the plurality of prediction coefficients, the set of nᵣₑₛ directly coded prediction residuals and the plurality of cross-prediction coefficients.

In some embodiments, reconstructing the input HOA audio signal may further include calculating an indication of remaining energy not accounted for by the prediction coefficients and the plurality of cross-prediction coefficients based on the plurality of decorrelator coefficients, and a plurality of decorrelated versions of the W channel.

In accordance with a third aspect of the present disclosure there is provided an apparatus for encoding Higher Order Ambisonics, HOA, audio. The apparatus may comprise one or more processors configured to implement a method including: receiving an input HOA audio signal having more than four Ambisonics channels; encoding the HOA audio signal using a SPAR coding framework and a core audio encoder; and providing the encoded HOA audio signal to a downstream device, the encoded HOA audio signal including core encoded SPAR downmix channels and encoded SPAR metadata.

In accordance with a fourth aspect of the present disclosure there is provided an apparatus for decoding Higher Order Ambisonics, HOA, audio. The apparatus may comprise one or more processors configured to implement a method including: receiving an encoded HOA audio signal, the encoded HOA audio signal having been obtained by applying a SPAR coding framework and a core audio encoder to an input HOA audio signal having more than four Ambisonics channels; decoding the encoded HOA audio signal to obtain a decoded HOA audio signal, decoded HOA audio signal including core decoded SPAR downmix channels and decoded SPAR metadata; and reconstructing the input HOA audio signal based on the decoded HOA audio signal to obtain, as an output HOA signal, a reconstructed input HOA audio signal.

In accordance with a fifth aspect of the present disclosure there is provided an apparatus including memory and one or more processor configured to perform a method of encoding Higher Order Ambisonics, HOA, audio or a method of decoding Higher Order Ambisonics, HOA, audio.

In accordance with a sixth aspect of the present disclosure there is provided a system of an apparatus for encoding Higher Order Ambisonics, HOA, audio and an apparatus for decoding Higher Order Ambisonics. HOA, audio.

In accordance with a seventh aspect of the present disclosure there is provided a program comprising instructions that, when executed by a processor, cause the processor to carry out a method of encoding Higher Order Ambisonics. HOA, audio or a method of decoding Higher Order Ambisonics, HOA, audio.

In accordance with an eighth aspect of the present disclosure there is provided a computer-readable storage medium storing said program.

### BRIEF DESCRIPTION OF THE DRAWINGS

Example embodiments of the disclosure will now be described, by way of example only, with reference to the accompanying drawings in which:

FIG. 1 illustrates an example of a block diagram of a codec for encoding and decoding HOA audio signals according to embodiments of the disclosure.

FIG. 2 illustrates an example of a method of encoding Higher Order Ambisonics, HOA, audio according to embodiments of the disclosure.

FIG. 3 illustrates an example of a method of decoding Higher Order Ambisonics, HOA, audio according to embodiments of the disclosure.

FIG. 4 illustrates an example of a block diagram of an HOA encoder including a SPAR HOA encoder and a core encoder according to embodiments of the disclosure.

FIG. 5 illustrates an example of a block diagram of a SPAR HOA encoder according to embodiments of this disclosure.

FIG. 6 illustrates an example of a block diagram of an HOA decoder including a SPAR HOA decoder and a core decoder, the SPAR HOA decoder including a metadata decoder, a predictor⁻¹, a cross-predictor⁻¹ configured to carry out inverse encoder side operations and decorrelators according to embodiments of the disclosure.

### DESCRIPTION OF EXAMPLE EMBODIMENTS

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system, apparatus or method for purposes of illustration only. One skilled in the art will readily recognize from the following description that alternative embodiments of the structures and methods illustrated herein may be employed without departing from the principles described herein.

### Immersive Voice and Audio Services (IVAS) Framework

First, possible implementations of the IVAS framework, as a non-limiting example of a framework to which the techniques of the present disclosure are applicable, will be described.

IVAS provides a spatial audio experience for communication and entertainment applications. The underlying spatial audio format is typically FOA. For example, four signals (W, Y, Z, X) are coded which allow rendering to any desired output format like immersive speaker playback or binaural reproduction over headphones. Depending on a total available bitrate, 1, 2, 3, or 4 downmix channels may be transmitted over a core audio codec at low latency. The W channel is transmitted unmodified or modified (in the case of active W) such that better prediction of the remaining channels is possible. The downmix channels are, except for the W channel, residual signals after prediction (prediction residuals) generated along with respective parameters (metadata), so called SPAR parameters. The SPAR parameters may be encoded per perceptually motivated frequency bands and the number of bands is typically 12.

At the decoder, the four FOA signals are reconstructed by processing the downmix channels and decorrelated versions thereof using transmitted parameters. This process may also be referred to as upmix and the parameters (metadata) are called SPAR parameters. The IVAS decoding process includes core decoding and SPAR upmixing. The core decoded signals may be transformed by a complex-valued low latency filter bank. After SPAR upmixing in the frequency domain, FOA time domain signals are generated by filter bank synthesis.

Methods and apparatuses as described herein may relate to expanding the SPAR algorithm to Higher Order Ambisonics, in particular, to enhancing the SPAR algorithm to achieve good results within the IVAS framework.

### HOA Audio Coding and Decoding Using SPAR

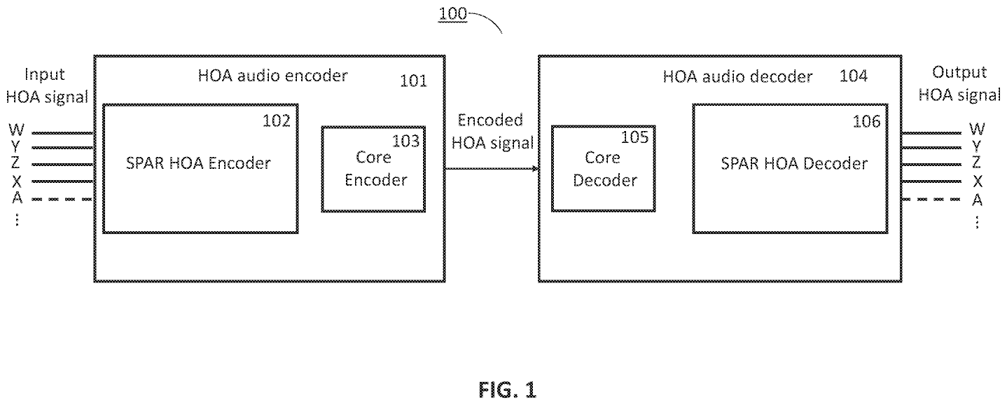

Referring to FIG. 1, an example of a block diagram of an encoder/decoder (“codec”) 100 for encoding and decoding HOA audio signals is schematically illustrated. The audio coder/decoder may have one or more input and output channels, e.g., may be a mono or a multi-channel codec.

In particular, the schematic example of FIG. 1 illustrates an HOA encoder 101 and an HOA decoder 104 which is located downstream the HOA encoder 101. The HOA codec 100 includes a SPAR HOA codec 102, 106 and a respective core codec 103, 105 for encoding and decoding the HOA audio, for example, for generating and decoding IVAS bitstreams in HOA format. The core codec 103, 105 may be a low latency core codec.

As illustrated in the example of FIG. 1, the HOA audio encoder 101 receives an input HOA audio signal with more than four Ambisonics channels (W, Y, Z, X, A . . . ), that is (N+1)² Ambisonics channels with N>1, where A . . . represents a plurality of higher order signals. In some embodiments, the more than four Ambisonics channels received by the HOA audio encoder 101 may also be a subset of the (N+1)² Ambisonics channels. Using the SPAR HOA encoder 102 and the core encoder 103, the received input HOA audio signal is encoded. The encoded HOA audio signal includes core encoded SPAR downmix channels as output by the core encoder 103 and encoded SPAR metadata as output by the SPAR HOA encoder 102. The encoded HOA audio signal is then provided to a respective downstream device, for example, as an IVAS bitstream. The IVAS bitstream may include a respective audio bitstream including the core encoded downmix channels and a metadata bitstream including the encoded SPAR metadata. Notably, the HOA audio encoder 101 may be an IVAS encoder.

At the downstream device, the encoded HOA audio signal is received by a respective HOA audio decoder 104, for example, as an IVAS bitstream. Notably, the HOA audio decoder 104 may be an WAS decoder. The encoded HOA audio signal is decoded using the core decoder 105 to obtain the decoded HOA audio signal. The decoded HOA audio signal includes the core-decoded SPAR downmix channels as output by the core decoder 105 as well as decoded SPAR metadata as obtained in the SPAR HOA decoder 106. Based on the decoded HOA audio signal (downmix channels and SPAR metadata), the input HOA audio signal is reconstructed using the SPAR HOA decoder 106 to obtain the respective output HOA audio signal (W, Y, Z, X, A . . . ). Notably, the output HOA audio signal may also be said to be the reconstruction of the HOA input signal (as received by the HOA encoder).

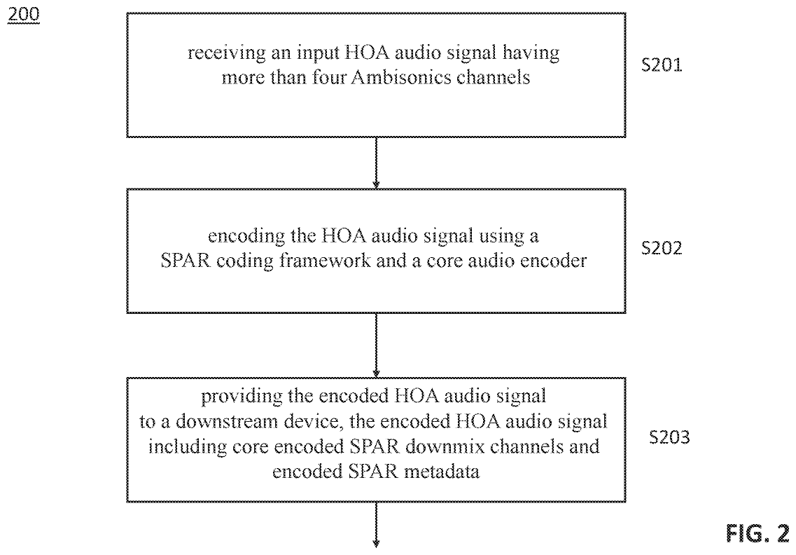

The example of FIG. 2 shows a respective method 200 of encoding HOA audio according to embodiments of the disclosure.

In step S201 an input HOA audio signal having more than four Ambisonics channels is received.

In step S202 the HOA audio signal is encoded using a SPAR coding framework and a core audio encoder.

And in step S203 the encoded HOA audio signal is provided to a downstream device, the encoded HOA audio signal including core encoded SPAR downmix channels and encoded SPAR metadata.

In an embodiment, the received (input) HOA audio signal may consist of Ambisonics channels that are ranked to have a relatively high perceptual importance as described below.

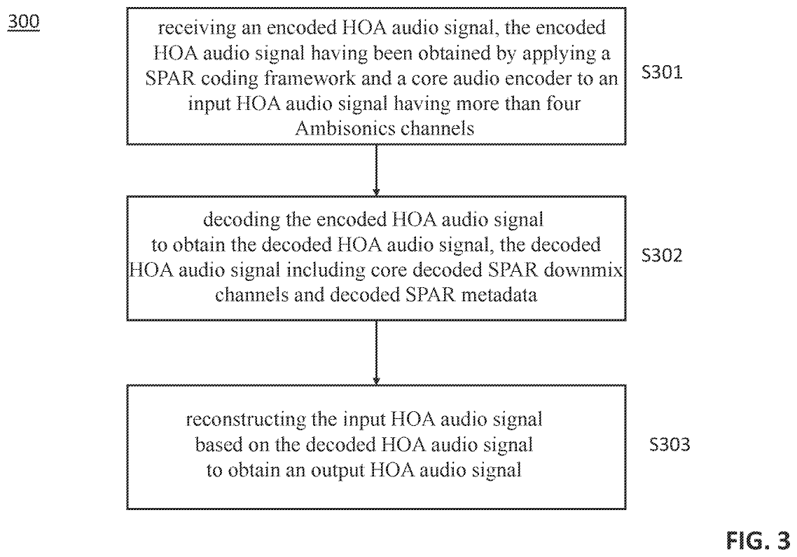

Referring now to the example of FIG. 3, a respective method 300 of decoding HOA audio according to embodiments of the disclosure is illustrated.

In step S301 an encoded HOA audio signal is received, the encoded HOA audio signal having been obtained by applying a SPAR coding framework and a core audio encoder to an input HOA audio signal having more than four Ambisonics channels.

In step S302 the encoded HOA audio signal is decoded to obtain the decoded HOA audio signal, the decoded HOA audio signal including core decoded SPAR downmix channels and decoded SPAR metadata.

And in step S303 the input HOA audio signal is reconstructed based on the decoded HOA audio signal to obtain an output HOA audio signal.

In an embodiment, the core decoded SPAR downmix channels may include a representation of a W channel and a set of nm directly coded prediction residuals. The decoded SPAR metadata may include a plurality of prediction coefficients, a plurality of cross-prediction coefficients, and a plurality of decorrelator coefficients.

Reconstructing the (input) HOA audio signal may include predicting a subset of the Ambisonics channels of the HOA audio signal based on the representation of the W channel and the plurality of prediction coefficients and adding in the set of nm directly coded prediction residuals. Adding in may be said to refer to combining the predicted Ambisonics channels with respective ones of the set of nm directly coded prediction residuals.

Reconstructing the (input) HOA audio signal may then further include determining remaining parametric channels based on the representation of the W channel, the plurality of prediction coefficients, the set of nᵣₑₛ directly coded prediction residuals and the plurality of cross-prediction coefficients.

And the reconstructing the (input) HOA audio signal may further include calculating an indication of remaining energy not accounted for by the prediction coefficients and the plurality of cross-prediction coefficients based on the plurality of decorrelator coefficients, and a plurality of decorrelated versions of the W channel.

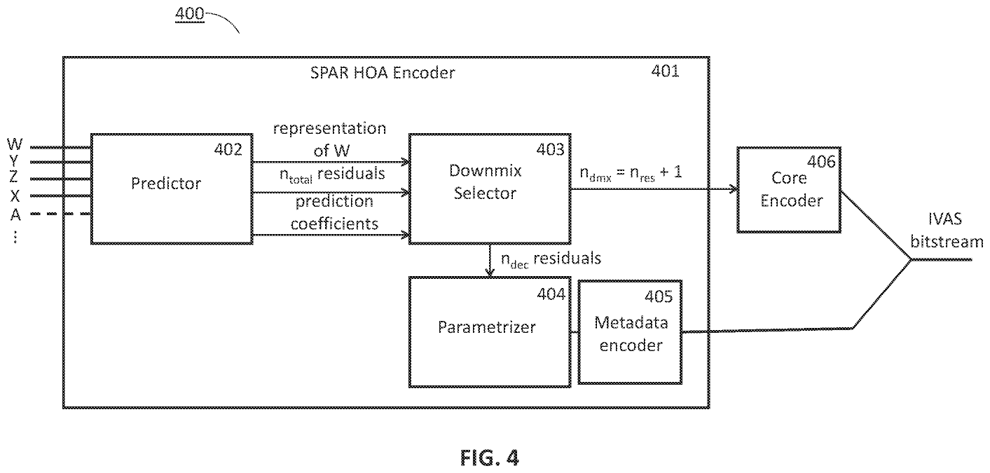

Referring to the example of FIG. 4, an example of a block diagram of a HOA encoder 400 including a SPAR HOA encoder and a core encoder is illustrated to describe the encoding in more detail.

The SPAR HOA encoder 401 may be said to be configured to convert the input HOA signal into a set of SPAR downmix, n_{dmx}, channels (W channel and selected prediction residuals) and SPAR metadata (parameters, coefficients) used to reconstruct the input signal at a HOA decoder. That is, in an embodiment, the encoding may include: generating, based on some or all of the Ambisonics channels, a representation of a W channel and a set of nₜₒₜₐₗ prediction residuals along with computing in SPAR metadata respective prediction coefficients. The W channel may always be sent intact.

The predictor 402 may receive the input HOA audio signal having the more than four Ambisonics channels (W, Y, X, Z, A . . . ). In the prediction step, the input channels may be converted to a representation of W and a set of nₜₒₜₐₗ=((N+1)²−1) prediction residuals (Y′, Z′, X′, A′ . . . ), along with respective prediction coefficients PR computed as SPAR metadata. These prediction coefficients may be used to calculate the downmix/transport channels.

Notably, as will be understood and appreciated by the skilled person, W may be a passive channel W or an active channel W′.

In said embodiment, out of the set of nₜₒₜₐₗ prediction residuals, a subset of nᵣₑₛ prediction residuals may be selected to be directly coded. The selection may be performed in a downmix selector 403, for example. The representation of W and the subset of nm prediction residuals represent the set of downmix channels n_{dmx} (n_{dmx}==nᵣₑₛ+1, where the additional 1 represents the W channel) sent to the core encoder 405. In other words, out of the nₜₒₜₐₗ prediction residuals, a number of nᵣₑₛ residuals may be coded directly, for example, 0 to (N+1)²−1. The core encoder 405 may be a low latency core encoder.

While, in principle, any channel configuration may be possible (from entirely residual coded to entirely parametric), since it is envisioned that HOA support will be at higher bitrates, it may be anticipated to have enough bits to send at least the first order residuals through the core codec. That is, the number of nm prediction residuals to be directly coded may be constrained.

In an embodiment, the selection of the subset of nm prediction residuals may be based on a threshold number for directly coded channels indicating a maximum number of directly coded channels. The threshold number for directly coded channels may be determined based on information indicative of one or more of a bitrate limitation, a metadata size, a core codec performance, and an audio quality. Bitrate limitation, metadata size, core codec performance, and audio quality thus constrain the number of the nᵣₑₛ prediction residuals to be directly coded.

In an embodiment, the threshold number for directly coded channels may be chosen from a predetermined set of threshold numbers for directly coded channels. The threshold numbers for directly coded channels may be said to be sensible numbers for directly coded prediction residuals given the respective constraints. Notably, the number of directly coded channels always includes a representation of the W channel.

In the SPAR framework, the coefficients (parameters, e.g., in metadata) for reconstructing the input HOA audio signal at the decoder may include some or all of prediction coefficients, cross-prediction coefficients and decorrelator coefficients.

In an embodiment, the encoding may thus further include representing parametric channels based on computing, in SPAR metadata, respective coefficients from the remaining n_{dec}=nₜₒₜₐₗ−nᵣₑₛ prediction residuals. In other words, the encoding may further include generating n_{dec}=nₜₒₜₐₗ−nᵣₑₛ parametric (parametrized) channels for encoding in metadata. This may be performed in a respective parametrizer 404, for example.

Subsequently, the SPAR metadata may be encoded in a respective metadata encoder 405 and a respective metadata bitstream may be generated. The n_{dmx} downmix channels may be encoded in a core encoder 406 and a respective audio bitstream may be generated. The metadata bitstream and the audio bitstream may then be combined into a respective IVAS bitstream output from the HOA encoder.

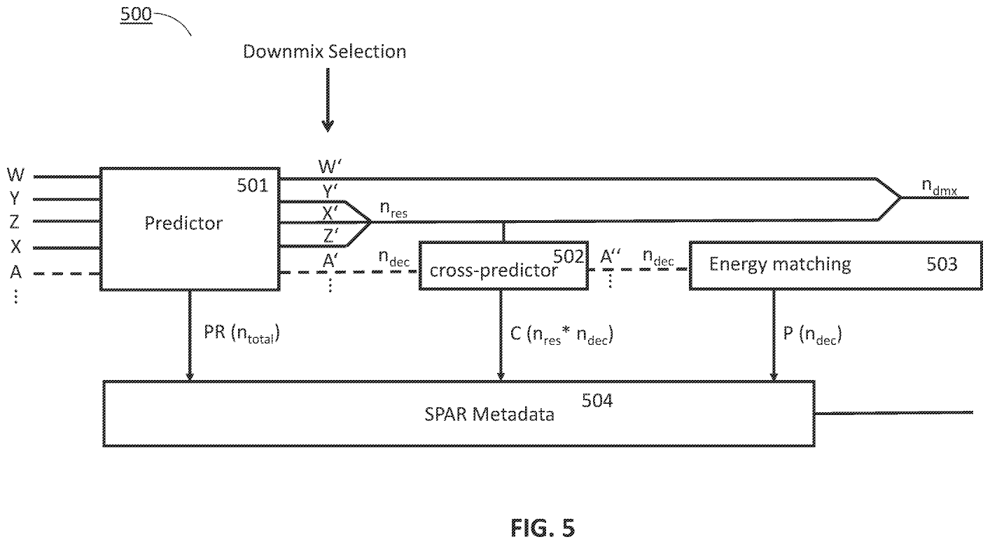

Referring to the example of FIG. 5, the SPAR HOA encoder 500 is illustrated in more detail, with an n_{dmx} of 4 selected for illustrative purposes.

In the predictor 501, a representation of the W channel and a set of nₜₒₜₐₗ prediction residuals along with respective prediction coefficients PR computed in SPAR metadata may be generated based on some or all of the received Ambisonics channels (W, Y, Z, X, A . . . ).

In selection of a particular downmix, e.g. n_{dmx}=4, out of the set of nₜₒₜₐₗ prediction residuals, the subset of nᵣₑₛ prediction residuals to be directly coded may be selected (e.g., Y′, X′ Z′).

The encoding may further include representing parametric channels based on computing, in SPAR metadata, respective coefficients from the remaining n_{dec}=nₜₒₜₐₗ−nᵣₑₛ prediction residuals.

In a second prediction step, in the cross-predictor 502, from the nᵣₑₛ residuals chosen to be coded directly to the n_{dec} residuals that will be parametrized, a series of cross-prediction, or C, coefficients may be created, along with n_{dec} cross-predicted residuals (A″, . . . ). That is, in an embodiment, the computing in SPAR metadata may include computing a plurality of cross-prediction coefficients for use by a decoder to reconstruct at least part of the n_{dec} parametric channels from the nᵣₑₛ directly coded prediction residuals.

Finally, the remaining cross-predicted residuals (A″, . . . ) may be used to calculate decorrelator coefficients, P, by energy matching 503. That is, in an embodiment, the computing in SPAR metadata may further include computing a plurality of decorrelator coefficients for use by the decoder to account, during reconstruction, for remaining energy not accounted for by the prediction coefficients and the cross-prediction coefficients. Coefficients may be calculated per band, from a banded covariance matrix generated from the input channels.

Overall, (N+1)²−1 prediction (PR) coefficients, nᵣₑₛ*n_{dec} cross-prediction (C) coefficients and n_{dec} decorrelation (P) coefficients may be generated (e.g., computed in SPAR metadata), per band. In many intermediate configurations, when nᵣₑₛ and n_{dec} are neither large nor small, the number of C coefficients may quickly dwarf the number of PR and P coefficients.

In general, a HOA decoder 104, 600 may be configured to reverse the operations that have been performed by the HOA encoder 101, 400 in order to obtain the output (reconstructed input) HOA audio signal.

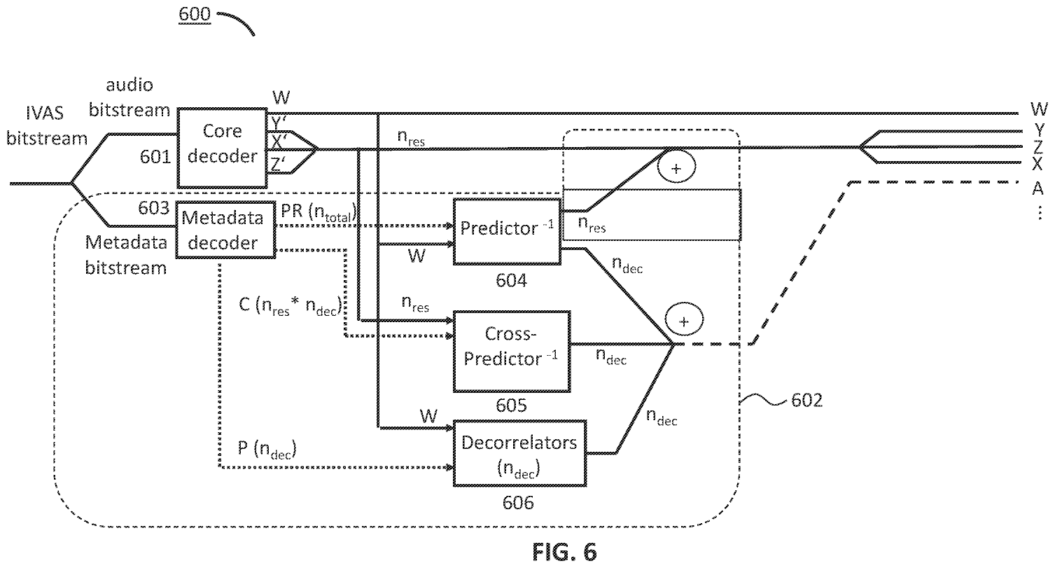

Referring to the example of FIG. 6, an example of a block diagram of an HOA decoder 600 including a SPAR HOA decoder 602 and a core decoder 601 is illustrated. The SPAR HOA decoder 602 includes a metadata decoder 603, a predictor⁻¹ 604, a cross-predictor⁻¹ 605 configured to carry out inverse encoder side operations (inverse prediction) and decorrelators 606. As will be explained in more detail below, carrying out the inverse encoder side operations may involve prediction from reconstructed W (using prediction coefficients) and prediction from the reconstructed residual channels (using cross-prediction coefficients) and combining the predicted signals either with residual channels or combining them with decorrelator output signals.

The HOA decoder 600 may be configured to receive an encoded HOA audio signal, the encoded HOA audio signal having been obtained by applying a SPAR coding framework and a core audio encoder to an input HOA audio signal having more than four Ambisonics channels. The encoded HOA audio signal may be received, for example, in the form of an WAS bitstream or a core-codec bitstream. The bitstream may include a metadata bitstream and an audio bitstream. In an embodiment, the encoded HOA audio signal may include core encoded SPAR downmix channels that may be a representation of a W channel and a set of nᵣₑₛ directly coded prediction residuals. The encoded HOA audio signal may further include encoded SPAR metadata that may be some or all of a plurality of prediction coefficients, a plurality of cross-prediction coefficients, and a plurality of decorrelator coefficients. The representation of the W channel and the set of nᵣₑₛ directly coded prediction residuals may be encoded in the audio bitstream, w % bile the plurality of prediction coefficients, the plurality of cross-prediction coefficients, and the plurality of decorrelator coefficients may be encoded in the metadata bitstream.

Notably, the prediction coefficients may be used to minimize the predictable energy in the residual downmix channels. The cross-prediction coefficients may be used to further assist in regenerating fully parametrized channels from the residuals. And the decorrelator coefficients may be used to fill in the remaining energy not accounted for by the prediction and decorrelator coefficients.

The core decoder 601 may be configured to core decode the audio bitstream to obtain core decoded SPAR downmix channels. The core decoded SPAR downmix channels may include a respective set of nm prediction residuals (Y′, X′, Z′) and the representation of the W channel. The W channel, the set of nᵣₑₛ prediction residuals together with the metadata bitstream may be sent to the SPAR HOA decoder 602. In the metadata decoder 603, the metadata bitstream may be decoded to obtain the decoded SPAR metadata. The decoded SPAR metadata may include some or all of a plurality of prediction coefficients, a plurality of cross-prediction coefficients, and a plurality of decorrelator coefficients.

The SPAR HOA decoder 602 may be configured to reconstruct the input HOA audio signal based on the decoded HOA audio signal, that is based on the core decoded SPAR downmix channels and the decoded SPAR metadata, to obtain an output HOA audio signal (reconstruction of the input HOA audio signal).

Reconstructing the input HOA audio signal by the SPAR HOA decoder 602 may include predicting (generating), in the predictor⁻¹ 604, a subset of the Ambisonics channels of the HOA audio signal based on the representation of the W channel and the plurality of prediction coefficients. The set of nᵣₑₛ directly coded prediction residuals may be added in subsequently.

Reconstructing the input HOA audio signal may then further include determining remaining parametric channels based on the set of nᵣₑₛ directly coded prediction residuals and the plurality of cross-prediction coefficients. As illustrated in FIG. 6, the remaining parametric channels (n_{dec}) may be regenerated by predicting from the W channel with prediction coefficients, and cross-predicting from the nᵣₑₛ directly coded prediction residuals using the cross-prediction coefficients. The latter may be done in the cross predictor⁻¹ 605 illustrated in FIG. 6. And the reconstructing the input HOA audio signal may further include calculating an indication of (incorporation of) remaining energy not accounted for by the prediction coefficients and the plurality of cross-prediction coefficients based on the plurality of decorrelator coefficients, and the output of a plurality of decorrelated versions of the W channel. This may be done in the decorrelators 606. In other words, the input covariance/signal energy may be matched using the decorrelator coefficients and decorrelated versions of the W channel.

All the steps used to reconstruct the residual channels and the parametric channels may effectively be summarized as follows:
Residual channels: W and prediction from W and nᵣₑₛ PR coefficients;
Parametric channels: prediction from W and n_{dec} PR coefficients, cross-prediction from residuals and C coefficients, and addition of decorrelation from P coefficients and decorrelated versions of W.

As will be understood and appreciated by the skilled person, the HOA decoder 600 may include one or more decorrelator blocks. The decorrelator blocks may be used to generate decorrelated versions of the W channel using a time domain or frequency domain decorrelator. The downmix channels and decorrelated channels may be used in combination with the metadata for parametric reconstruction by the SPAR HOA decoder.

As will further be understood and appreciated by the skilled person, the HOA encoder 400 may further additionally include a mixer and the HOA decoder 600 may then further additionally include an inverse mixer, to achieve a preferred internal channel ordering and output channel ordering, respectively.

### SPAR Channel Ranking Extension

Ambisonics input to SPAR is assumed to be SN3D normalized and using ACN channel ordering. SPAR makes use of a preferred internal channel ranking that is slightly different to ACN, in order to give more spatially perceptually relevant channels greater importance, and therefore higher priority to be sent as a residual, rather than as a parametrized (parametric) channel.

Given an original input of channels {W=0, Y=1, Z=2, X=3, . . . } Ambisonics channels can be described in terms of their channel letter designations (e.g. W, Y, Z, X, . . . ), or ACN channel number (0, 1, 2, 3, . . . ) or individually by their “mode”, or order and degree, (1 (or n), m).

$$\# ACN = {l}^{2} + l + m \qquad ( 1 )$$

Ambisonics channels can further be described in terms of spherical harmonics as shown in Table 1. In this table, φ and θ are the azimuth and elevation direction of arrival angles of the source. It is understood however that the definitions of the spherical harmonics as given in Table 1 are examples only and that other definitions, normalizations, etc. are feasible in the context of the present disclosure.

TABLE 1
Table of spherical harmonics in SN3D for HOA3 input with ACN ordering

| | | | | Letter | | | |
|---|---|---|---|---|---|---|---|
| | | | | #ACNi | | | |
| | | | | Yₙ^{m}(θ, φ), Yᵢ | | | |
| Order | | | | (n, m) | | | |
| 0 | | | | W | | | |
| | | | | 0 | | | |
| | | | | 1 | | | |
| | | | | (0, 0) | | | |
| 1 | | | Y | Z | X | | |
| | | | 1 | 2 | 3 | | |
| | | | sin(θ)cos(φ) | sin(φ) | cos(θ)cos(φ) | | |
| | | | (1, −1) | (1, 0) | (1, 1) | | |
| 2 | | $\begin{matrix}V \\ 4 \\ \frac{\sqrt{3}}{2} sin ( 2 θ ) {cos}^{2} ( φ ) \\ ( 2 , - 2 )\end{matrix}$ | $\begin{matrix}T \\ 5 \\ \frac{\sqrt{3}}{2} sin ( θ ) sin ( 2 φ ) \\ ( 2 , - 1 )\end{matrix}$ | $\begin{matrix}R \\ 6 \\ \frac{1}{2} ( 3 {sin}^{2} ( φ ) - 1 ) \\ ( 2 , 0 )\end{matrix}$ | $\begin{matrix}S \\ 7 \\ \frac{\sqrt{3}}{2} cos ( θ ) sin ( 2 φ ) \\ ( 2 , 1 )\end{matrix}$ | $\begin{matrix}U \\ 8 \\ \frac{\sqrt{3}}{2} cos ( 2 θ ) {cos}^{2} ( φ ) \\ ( 2 , 2 )\end{matrix}$ | |
| 3 | $\begin{matrix}Q \\ 9 \\ \sqrt{\frac{5}{8}} sin ( 3 θ ) {cos}^{3} ( φ ) \\ ( 3 , - 3 )\end{matrix}$ | $\begin{matrix}O \\ 10 \\ \frac{\sqrt{15}}{2} sin ( 2 θ ) \\ sin ( φ ) {cos}^{2} ( φ ) \\ ( 3 , - 2 )\end{matrix}$ | $\begin{matrix}M \\ 11 \\ \sqrt{\frac{3}{8}} sin ( θ ) \\ ( 5 {sin}^{2} ( φ ) - 1 ) cos ( φ ) \\ ( 3 , - 1 )\end{matrix}$ | $\begin{matrix}K \\ 12 \\ \frac{1}{2} sin ( φ ) \\ ( 5 {sin}^{2} ( φ ) - 3 ) \\ ( 3 , 0 )\end{matrix}$ | $\begin{matrix}\begin{matrix}\begin{matrix}L \\ 13\end{matrix} \\ \sqrt{\frac{3}{8}} cos ( θ ) ( 5 {sin}^{2} ( φ ) - 1 ) cos ( φ )\end{matrix} \\ ( 3 , 1 )\end{matrix}$ | $\begin{matrix}N \\ 14 \\ \frac{\sqrt{15}}{2} cos ( 2 θ ) \\ ( sin ( φ ) {cos}^{2} ( φ ) \\ ( 3 , 2 )\end{matrix}$ | $\begin{matrix}P \\ 15 \\ \sqrt{\frac{5}{8}} \\ cos ( 3 θ ) {cos}^{3} ( φ ) \\ ( 3 , 3 )\end{matrix}$ |

As addressed above, in an embodiment, out of the set of nₜₒₜₐₗ prediction residuals, a subset of nᵣₑₛ prediction residuals may be selected to be directly coded. The selection of the subset of nᵣₑₛ prediction residuals may be based on a threshold number for directly coded channels indicating a maximum number of directly coded channels. The maximum number of directly coded channels may be said to correspond to the number of downmix channels.

Referring again to the example of FIG. 4, the subset of nᵣₑₛ prediction residuals may be selected in accordance with a channel ranking of the Ambisonics channels starting from high-ranked to low-ranked channels. The channel ranking of the Ambisonics channels may be based on a channel ranking agreement between encoder and decoder. Alternatively, or additionally, the channel ranking of the Ambisonics channels may be based on a perceptual importance of the Ambisonics channels, with Ambisonics channels being higher in the channel ranking having higher perceptual importance.

For First Order Ambisonics, the preferred SPAR FOA internal ranking is {0, 1, 3, 2} or {W, Y, X, Z} given the assumptions that sound directions in the Y direction (left-right) are more perceptually relevant than those from the X or Z direction. Similarly, sounds in the X-Y plane are more relevant than height information, placing X before Z. Extending this logic to HOA is non-trivial, as many conflicting options are possible.

### Channels in the X-Y Plane

In an embodiment, Ambisonics channels corresponding to a spherical harmonic Yₗ^{m}(θ, φ) with larger overlap with a left-right-front-rear plane may be ranked to be perceptually more important than Ambisonics channels corresponding to a spherical harmonic Yₗ^{m}(θ, φ) with larger overlap with a height direction, for a given order l (where the order l may correspond to the order n used in Table 1, with 0≤l≤N for HOA order N). For the Ambisonics channels corresponding to a spherical harmonic Yₗ^{m}(θ, φ) with larger overlap with a height direction, those with lesser overlap with the height direction may further be promoted over those with larger overlap with the height direction.

Alternatively, or additionally, pairs formed by Ambisonics channels corresponding to spherical harmonics Yₗ^{m}(θ, φ) for a given order l with |m|=l may be ranked to be perceptually more important than HOA channels for the given order l with |m|<l.

[1] Promoting channels in the X-Y (left-right-front-rear) plane {4, 8} above those with weaker {5, 7}, then more dominant {6} Z (height) components may lead to a pattern of {0, 1, 3, 2, 4, 8, 5, 7, 6, . . . }.
which takes the pairs of channels from the outside of each order of the HOA pyramid towards the center, compare, for example, Table 1.

Notably, the center channel of all even orders, e.g. channel {6} (mode (2,0)) in second order, actually has a lobe in the X-Y plane. As such it could be argued that it is more perceptually relevant than the {5, 7} pair, and thus could be promoted above it.

This would result, e.g., in a pattern of {0, 1, 3, 2, 4, 8, 6, 5, 7, . . . }.

However, given that some HOA2 (HOA second order) microphone array providers choose to leave this channel empty in their conversion to Ambisonics, it may also be reasonable to apply the previously described pattern, that is, to demote 6, or, in other words, not to promote 6.

[2] As to the order of channel pairs, it could be argued why {4, 8} and not {8, 4}. Either are possible, however, keeping the pattern of the first order, where the Y channel (1,−1) comes before the X channel (1,1), an embodiment would be to take the (n,−m) mode before the (n, m) mode. That is, in an embodiment, Ambisonics channels corresponding to a spherical harmonic Yₗ^{m}(θ, φ) with larger overlap with a left-right direction may be ranked to have higher perceptual importance than Ambisonics channels corresponding to a spherical harmonic Yₗ^{m}(θ, φ) with larger overlap with a front-rear direction.

Alternatively, the choice of which to place first may also be made adaptively, e.g., based on some energy criterion. See the later point about increasing the downmix channels n_{dmx} beyond 4 channels.

### Order l-1 Before Order l

In an embodiment, the channel ranking of the Ambisonics channels corresponding to spherical harmonics Yₗ^{m}(θ, φ) of a given order l may form a subset of the channel ranking of the Ambisonics channels corresponding to spherical harmonics Yₗ₊₁^{m}(θ, φ) of an (l+1)-th order, the channel ranking of the Ambisonics channels of the (l+1)-th order starting with the channel ranking of the Ambisonics channels of the l^{th} order.

[3] For the purposes of bitrate switching, whereby input audio of a particular (high) order may be coded at a lower order at some bitrates and the original order at others, it is useful for the internal SPAR channel ranking for a given order to be a subset of a higher order: e.g. FOA⊂HOA2⊂HOA3. As such it may be beneficial to ensure all lth order channels appear before 1+1th order channels.

FOA: {0, 1, 3, 2}

HOA2: {0, 1, 3, 2, 4, 8, 5, 7, 6}

HOA3: {0, 1, 3, 2, 4, 8, 5, 7, 6, 9, 15, 10, 14, 11, 13, 12} (2)

### Planar Channels Before Non-Planar Channels

In an embodiment, Ambisonics channels corresponding to a spherical harmonic Yₗ^{m}(θ, φ) with larger overlap in (with) the left-right-front-rear plane of a given order l may be ranked to have higher perceptual importance than Ambisonics channels corresponding to a spherical harmonic Yₗ₋₁^{m}(θ, φ) of an (l-1)-th order with larger overlap in the height direction.

[4] It can also be argued that channels predominantly in the plane from a higher order are more perceptually relevant than height channels from a lower order, up to a point. It could be argued that the 1^{st} order Z channel gives enough low resolution height information, and that 2^{nd} and 3^{rd} (or higher) order planar information could be more relevant and preferred to be residually coded over the 2^{nd} order height channels, such that an HOA ranking could be;

FOA: {0, 1, 3, 2}

HOA2: {0, 1, 3, 2, 4, 8, 5, 7, 6}

HOA3: {0, 1, 3, 2, 4, 8, 9, 15, 5, 7, 6, 10, 14, 11, 13, 12} (3)

Differences between the rankings of eq. (2) and eq. (3) may become more prominent if 6 or more downmix channels are selected to be directly coded.

Increasing the Number of Downmix Channels n_{dmx}≥4

For FOA, there is a distinct benefit for every additional downmix channel beyond the W channel. From second order onwards, it becomes harder to motivate adding individual channels in many cases based on their spatial relevance.

For example, for n_{dmx}=5, it becomes hard to choose which of the {4, 8} channel pair to send. Instead it may be preferable to add downmix channels in (n,+/−m) pairs, where present, i.e. both {4, 8}. If using the ranking from eq. (2), sensible choices for n_{dmx} therefore might be 1, 2, 3, 4, 6, 8, 9, 11, 13, 15, 16, and so on.

If an n_{dmx} not listed above is desired for other reasons, e.g. bitrate constraints, as mentioned in point marked [2] above, the final residual sent could be chosen adaptively. That is, in an embodiment, one or more prediction residuals to be subsequently added to the subset of nᵣₑₛ prediction residuals may be selected based on a ranking promoting Ambisonics channels corresponding to a spherical harmonic Yₗ^{±l}(θ, φ) over Ambisonics channels corresponding to a spherical harmonic Yₗ^{θ}(θ, φ) ahead of Ambisonics channels corresponding to a spherical harmonic Yₗ^{m}(θ, φ), where 0<|m|<1.

Choice of Downmix Channels n_{dmx}

While the SPAR algorithm supports any choice of n_{dmx} between 1 and (N+1)², the choice of the number of downmix channels to send may dependent on the available bitrate, the size of the coded metadata, and any other real-world considerations that might apply, e.g. core codec performance, complexity and memory constraints.

If HOA is deemed to be a high quality mode of operation, it makes sense that a lower limit for HOA n_{dmx} could be chosen based on the highest quality FOA mode, e.g. n_{dmx}=4. With so many input channels, once taking account for the required metadata, permitting n_{dmx} to approach (N+1)² means that the average per-channel bitrate becomes very low. When trying to boost the bitrates for lower order channels, e.g. for W, X, Y, Z channels, to levels that worked well for FOA operation, the problem of trying to encode higher order residuals with extremely poor quality/low bitrate core codec instances may occur. Given the constraints of a core-codec, n_{dmx}<=8 may be a reasonable choice.

Taking computational complexity/memory footprint into account, it may make sense to further limit the number of downmix channels to that of the highest quality FOA mode, e.g. max n_{dmx}=4.

Trying to operate in HOA modes in extremely bitrate limited scenarios may necessitate the use of n_{dmx}=3, which may prove to be an acceptable tradeoff between audio quality and spatial metadata quality.

Given that it may be unlikely to go beyond n_{dmx}=4, the preferred SPAR HOA internal channel ranking may be as given in eq. (2), which combines the logic of points marked [1]-[3] above.

For HOA2, this creates 3×5 C coefficients per band, and for HOA3 modes, 3×12 C coefficients per band. This is close to the maximum possible cross-prediction metadata for HOA2, and somewhat less than the maximum for HOA3 but nowhere near the minimum, which means that a large portion of the bitrate would be reserved for metadata (MD).

### Computation of Prediction Coefficients for Higher Order Channels

The computation of prediction coefficients in SPAR for a FOA input may be determined based on input covariance matrices. In one example;

$${pr}_{y} = \frac{{R}_{YW}}{max ( {R}_{WW} , ε )} \frac{1}{max ( 1 , \sqrt{{\vert {R}_{YW} \vert}^{2} + {\vert {R}_{ZW} \vert}^{2} + {\vert {R}_{XW} \vert}^{2}} )} \qquad ( 4 )$$

In the above, symbols of the form R_{AB} (where A and B are arbitrary channels among {W, X, Y, Z, . . . }) represent the elements of the input covariance matrix corresponding to two input signals A and B. When A!=B, this value is a cross-covariance, and when A=B, it is an auto-covariance, pr_{y} is the prediction coefficient corresponding to Y channel of FOA input.

Similarly, prediction coefficients corresponding to X and Z can be computed using the example method described in eq. (4).

The extension of eq. (4) to higher order channels is non-trivial as there can be multiple ways to normalize the covariance for higher order channels:

### Extending the Normalization to Higher Order Channels

$${pr}_{i} = \frac{{R}_{i W}}{max ( {R}_{WW} , ε )} \frac{1}{max ( 1 , {\sum }_{j = 1}^{{( N + 1 )}^{2} - 1} {\vert {R}_{jW} \vert}^{2} )} \qquad ( 5 )$$

In the above, R_{AB} represents the elements of the input covariance matrix of signals A and B, prᵢ is the prediction coefficient corresponding to ith channel of HOA input with ACN ordering, here ith channel can be any of the Ambisonics channel other than 0^{th} order W channel. N is the HOA order.

### Normalizing Each Order Separately Based on Spherical Harmonics Normalization

For a point source input, the prediction coefficient normalization mentioned in eq. (5) are likely to result in over normalization. For a point source input with perfect SN3D normalization and unity power, the covariance between W channel and any other input channel i of the Ambisonics input, R_{iW}, can be closely approximated as the spherical harmonic response corresponding to channel i in Table 1. The ideal value of prediction coefficient for the ith channel in this case should be

$$p {r}_{i} = {Y}_{i} \qquad ( 6 )$$

such that all the channels of the Ambisonics input can be perfectly reconstructed using just W channel and the prediction coefficients.

Here, Yᵢ is the spherical harmonic response corresponding ACN channel i of Ambisonics input as per Table 1.

However, if eq. (5) is used to compute prᵢ then after substituting R_{iW}=Yᵢ in eq. (5) it results in prᵢ=Yᵢ/l, where l corresponds to the order of ACN channel i with corresponding mode (1,m), as the SN3D normalized spherical harmonics corresponding to each order form a unit vector. So

$$\frac{1}{max ( 1 , {\sum }_{j = 1}^{{( N + 1 )}^{2} - 1} {\vert {R}_{jW} \vert}^{2} )} = \frac{1}{n} \qquad ( 7 )$$

Here, order is the Ambisonics input order N. Normalization as per eq. (7) results in under prediction, which leads to higher post prediction error and then could lead to coding issues.

Hence, it is desired to normalize the prediction coefficients for each order separately as shown in the example implementation below

$${pr}_{l , i} = \frac{{R}_{iW}}{max ( {R}_{WW} , ε )} \frac{1}{max ( 1 , {\sum }_{j = a}^{b} {\vert {R}_{jW} \vert}^{2} )} \qquad ( 8 )$$

Here, pr_{l,i} is the prediction coefficient corresponding to ith input channel (ACN) corresponding to an order l. a and b are the starting and ending channel indices for order l. The mapping of i and l and the ACN values of a=(l+1)²−2l−1 and b=(l+1)²−1 can be used from Table 1 (notably in Table 1 n instead of l is used). Example computation of prediction coefficients corresponding to 2^{nd} order channel V of the Ambisonics input is given below

$${pr}_{2 , V} = \frac{{R}_{VW}}{max ( {R}_{WW} , ε )} \frac{1}{max ( 1 , {\sum }_{j = 4}^{8} {\vert {R}_{jW} \vert}^{2} )} \qquad ( 9 )$$

It is important to note that the normalization term in eq. (5) and eq. (8) is such that the prediction coefficients are always in desired quantization range and minimizes the post prediction error.

### Frequency Based Improved Time Resolution for Prediction of Parametric Channels

The post prediction error variance in ACN channel i of Ambisonics input of order l can be given as

$${E}_{i} = {R}_{ii} - {R}_{WW} * {pr}_{i}^{2} \qquad ( 10 )$$

It is desired to reduce E to minimize coding artifacts. A higher value of E can result in high decorrelation contribution from decorrelators and can lead to audio artifacts.

Improvement in computation of pr coefficients helps with reducing the value of E and reduces the dependency on decorrelators. One way to improve the value prediction coefficients is to improve the time resolution of the analyses window and covariance estimates when computing prediction coefficients. The idea here is to improve the time resolution only for parametric channels such that encoder filterbank and computational complexity is not impacted. An example implementation is mentioned below:

If the input is HOA3 and n_{dmx}=4, assuming the encoder filterbank time resolution and optionally crossfading window length as t₁ milliseconds. Compute two sets of covariance estimates, one with same time resolution of t₁ milliseconds as encoder filterbank and second with the time resolution of t₂ milliseconds such t₂<t₁. The choice of t₂ time resolution depends on the decoder filterbank.

Compute the prediction coefficient values with t₁ milliseconds time resolution covariance estimates for n_{dmx} channels. If the core coder codes the n_{dmx} channels with perfect waveform reconstruction then the n_{dmx} channels of the Ambisonics input can be perfectly reconstructed using the prediction coefficients with the time resolution of t₁ milliseconds.

Compute the prediction coefficient values with t₂ milliseconds time resolution covariance estimates for the parametric channels. This results in improved prediction coefficients especially in high frequencies and reduces the post predicted error E. For parametric channels, the post predicted error signal is not coded by the core coders and instead it is estimated by decorrelators at the decoder.

In an example implementation, t₁ is equal to 20 and t₂ is equal to 5.

In an example implementation, t₂ milliseconds time resolution covariance estimates are used only in higher frequencies. In another example implementation, t₂ milliseconds time resolution covariance estimates are used upon detection of transients.

The improved time resolution of prediction coefficients for parametric channels does not impact the computation of downmix channels and hence maintains the low computational complexity at the encoder side. In an example implementation, improved time resolution of prediction coefficients requires additional metadata to be coded in IVAS bitstream.

In an example implementation, improved time resolution of prediction coefficients requires a filterbank with finer time resolution at the decoder in order to apply the prediction coefficients to the corresponding time-frequency tile.

### HOA Metadata Encoding

PCT/US2021/036886 and U.S. Provisional Application No. 63/037,784 describe a looped approach to encoding SPAR metadata, which relies on a series of quantization strategies (which determine how the metadata is quantized), a target metadata bitrate, and a maximum metadata bitrate. The quantized metadata is encoded using a variety of encoding schemes (non-differential, time-differential (striped), frequency-differential), and encoder models. If the metadata is able to be encoded under the target bitrate, the loop ends. If not, it will continue to try more schemes, and coding models. If after all these attempts, it is less than the maximum specified metadata bitrate, the most efficient coding will be selected, and the loop will end. If not, the loop moves on to the second quantization strategy, and then the third (final). The final quantization strategy is coarse enough that the base-2 coded MD is guaranteed to fit within the maximum metadata bitrate budget.

HOA metadata encoding may be subject to bitrate constraints. Bitrate constraints may be a target metadata bitrate to meet or a maximum bitrate for metadata encoding. In an embodiment, the encoding may thus include obtaining a bitrate limitation value, selecting, out of a set of SPAR quantization modes, a SPAR quantization mode to meet the bitrate limitation value and applying the selected SPAR quantization mode to the SPAR metadata.

Metadata that is encoded below the target metadata bitrate means that there are excess bits that can be distributed amongst the core coders to encode the audio. Conversely, if the metadata is encoded above the target bitrate, the extra bits are taken from the allocations for the individual core coders, according to a distribution strategy.

In an embodiment, some or all of the modes in the set of SPAR quantization modes may thus include re-allocating bits to coefficients relating to Ambisonics channels being ranked higher in the channel ranking from coefficients relating to Ambisonics channels being ranked lower in the channel ranking.

The relationship between a target and worst-case/maximum metadata bitrate is something that drives the metadata encoding. Similarly, it has a significant effect on the actual bitrates used by the core coder to perform the audio coding.

In FOA modes, there is fewer metadata to deal with, i.e., fewer coefficients, and associated quantization schemes range from acceptable quality (at low bitrates) to high quality/fine quantization at high bitrates. Typical target and worst case FOA metadata bitrates are 10 kbps and 15 kbps, respectively.

In HOA modes, there are significantly more coefficients to encode, as well as an expectation of higher quality, where possible. Using a similar approach as FOA, target bitrates may be on the order of 70 kbps for HOA3, and a worst-case bitrate of 130 kbps (even with relatively poor metadata quality). Encoding some finely-quantised metadata close to the worst-case limit (instead of slightly reducing the quality to a coarser quantisation and encoding closer to the target metadata bitrate) may force the audio channels to be encoded with significantly lower than preferred and often wildly fluctuating bitrates. This has a potential impact on audio quality.

Additionally, core coders may have preferred operating ranges, within which SPAR's minimum, target and maximum core coder bitrates should be located, as it may not be preferable to switch between two operating ranges for consistency of audio quality. Accounting for large fluctuations in the metadata bitrate within these constraints can be difficult, or even impossible.

The only way to solve this is to find a way to reduce the worst-case metadata bitrate. Several approaches for reducing the worst-case metadata have been explored:

### Exploit the Sparseness of the Matrices to be Encoded, e.g., Matrix of C Coefficients.

Analysis of the C coefficients can be done to determine if cross prediction was not useful (i.e., coefficients are zero) from particular residual channels to other parametric channels, or in particular bands. The C parameters may therefore be coded much more efficiently.

### Artificially Create Sparseness/Omit Low-Relevance Metadata

In an embodiment, some or all of the modes in the set of SPAR quantization modes may include selecting a subset of cross-prediction coefficients to be omitted from the plurality of cross-prediction coefficients.

Alternatively, or additionally, some or all of the modes in the set of SPAR quantization modes may include selecting a subset of decorrelator coefficients to be omitted from the plurality of decorrelator coefficients.

Selecting the subset of coefficients may be based on the channel ranking of the Ambisonics channels.

The biggest contributor to metadata bitrate in SPAR HOA is the prediction coefficients, due to the fact that they are known to be crucial to audio quality and thus are typically chosen to be quantized finely, requiring more bits to code. It is also expected that the prediction coefficients do the bulk of the work in reconstructing parametrized signals at the decoder.

At expected n_{dmx}=4, the C coefficients are by far the most numerous. They correspond to the cross-prediction between FOA residuals (Y′, X′, Z′) and all higher order channels, and therefore are ripe for reduction.

Setting C coefficients to zero all the time has significant impact on the audio quality. Doing so for a few frames, when the metadata happens to be difficult to encode has a much more limited effect.

Setting a specific subset (or all) of C coefficients to zero can be considered as a very coarse quantization of those parameters. This may lead to too low energy of the reconstructed signals. The decorrelator coefficients may or may not be permitted to make up for the cross-prediction “quantization error” in this case.

Given the bitrate constraints on the metadata it may become apparent that it is necessary to also remove the corresponding decorrelator. P, coefficients in the worst case as well to meet bitrate requirements. Further embodiments may include the option to code C coefficients but omit a subset of P coefficients, or in extremely bitrate limited cases to also omit related prediction, PR, coefficients.

C coefficients can be identified by their correspondence to a particular first order residual, a particular higher order parametric channel, and the band. As long as both the encoder and decoder know which coefficients have been omitted, any pattern of sparsity can be imposed on the C coefficients. Selecting a subset of C and/or P coefficients to remove can be perceptually motivated, e.g. similar to the reasoning behind channel ranking point [4], higher order planar channels could be preferred for full parametrization (i.e. sending their PR, C and P coefficients) over partly-parametrized non-planar channels (i.e. sending PR without C and/or P). This preference does not require to be imposed by the ordering of signals, given a specified n_{dmx}.

### Planar HOA C and P Coefficients

A reasonable assumption to make that eliminates a significant number of coefficients is that the higher order planar channels e.g. {5, 9}, {10, 16} are most relevant, while the higher order height related channels e.g. {6-8}, {11-15} are less so. Omitting the height-related channels for HOA3 reduces the number of cross-prediction and decorrelator coefficients by ⅔. Similarly, for HOA2, where channels {6-8} could be omitted, it is reduced by ⅗. Many other configurations are possible, depending on bitrate constraints. To make the required equivalent metadata bitrate reduction (for HOA3) without omitting coefficients, the quantization levels would need to drop far below the level of “good quality” determined from FOA tuning, which is not appropriate for HOA modes.

For FOA inputs, the three rounds of quantization levels would typically be slowly reducing in quality. For HOA, a similar result could be achieved by lowering the quantization levels from the original to the second instance, and then by maintaining the same quantization levels, but deliberately omitting the non-planar coefficients in the third case.

Using the previous example of HOA3 with an original maximum metadata bitrate of 130 kbps with coarse quantization, with Planar C and P coefficients only, that maximum bitrate was able to be reduced to around 84 kbps using a finer quantization for the included metadata.

### MD PLC for Worst Case Frames

From initial observations, we tend not to see the metadata entering this planar mode very often. The worst vector only does it for about 1-2 frames/s. As such, the audio degradation is not particularly noticeable. However, if SPAR is forced into this low-quality mode more often, it would be possible to apply Packet Loss Concealment (PLC)-like approaches which would treat unsent non-planar metadata as “lost”, using the last frame where the non-planar metadata was sent as a starting point for interpolation.

PLC—Packet Loss Concealment, refers to algorithms that allow a decoder to fill-in-the-blanks and construct some meaningful output, usually when an entire cache of information (packet), e.g. all audio and metadata, is lost for a particular frame, often due to network issues.

In this instance, we may not be losing all the audio/MD information, just a subset of the MD, and it would be possible to infer something somewhat sensible from the information received in a previous frame, in a similar manner, in order to fill-in-the-blanks for this deliberately excluded metadata.

Making Up for Omitted Decorrelator Coefficients in Other Ways Decorrelator coefficients are used to match the energy of the parametrized channel to their inputs, after prediction and/or cross-prediction. It may be possible to make up for lost energy in higher order channels that were chosen to have their P coefficients omitted by adjusting the coefficients of related lower order channels that were chosen to be fully parametrized, e.g. omission of the P coefficient for channel {12} could be made up for by boosting the P coefficients of channels {6} and/or {2}, if present.

### Interpretation

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

A computing device implementing the techniques described above can have the following example architecture. Other architectures are possible, including architectures with more or fewer components. In some implementations, the example architecture includes one or more processors (e.g., dual-core Intel® Processors), one or more output devices (e.g., LCD), one or more network interfaces, one or more input devices (e.g., mouse, keyboard, touch-sensitive display) and one or more computer-readable mediums (e.g., RAM, ROM, SDRAM, hard disk, optical disk, flash memory, etc.). These components can exchange communications and data over one or more communication channels (e.g., buses), which can utilize various hardware and software for facilitating the transfer of data and control signals between components.

The term “computer-readable medium” refers to a medium that participates in providing instructions to processor for execution, including without limitation, non-volatile media (e.g., optical or magnetic disks), volatile media (e.g., memory) and transmission media. Transmission media includes, without limitation, coaxial cables, copper wire and fiber optics.

Computer-readable medium can further include operating system (e.g., a Linux® operating system), network communication module, audio interface manager, audio processing manager and live content distributor. Operating system can be multi-user, multiprocessing, multitasking, multithreading, real time, etc. Operating system performs basic tasks, including but not limited to: recognizing input from and providing output to network interfaces and/or devices, keeping track and managing files and directories on computer-readable mediums (e.g., memory or a storage device); controlling peripheral devices; and managing traffic on the one or more communication channels. Network communications module includes various components for establishing and maintaining network connections (e.g., software for implementing communication protocols, such as TCP/IP, HTTP, etc.).

Architecture can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Unless specifically stated otherwise, as apparent from the following discussions, it is appreciated that throughout the present disclosure discussions utilizing terms such as “processing”, “computing”. “calculating”. “determining”, “analyzing” or the like, refer to the action and/or processes of a computer or computing system, or similar electronic computing devices, that manipulate and/or transform data represented as physical, such as electronic, quantities into other data similarly represented as physical quantities.

Reference throughout this disclosure to “one example embodiment”, “some example embodiments” or “an example embodiment” means that a particular feature, structure or characteristic described in connection with the example embodiment is included in at least one example embodiment of the present disclosure. Thus, appearances of the phrases “in one example embodiment”, “in some example embodiments” or “in an example embodiment” in various places throughout this disclosure are not necessarily all referring to the same example embodiment. Furthermore, the particular features, structures or characteristics may be combined in any suitable manner, as would be apparent to one of ordinary skill in the art from this disclosure, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present disclosure, various features of the present disclosure are sometimes grouped together in a single example embodiment, Fig., or description thereof for the purpose of streamlining the present disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this disclosure.

Furthermore, while some example embodiments described herein include some, but not other features included in other example embodiments, combinations of features of different example embodiments are meant to be within the scope of the present disclosure, and form different example embodiments, as would be understood by those skilled in the art. For example, in the following claims, any of the claimed example embodiments can be used in any combination.

In the description provided herein, numerous specific details are set forth. However, it is understood that example embodiments of the present disclosure may be practiced without these specific details. In other instances, well-known methods, structures and techniques have not been shown in detail in order not to obscure an understanding of this description.

Thus, while there has been described what are believed to be the best modes of the present disclosure, those skilled in the art will recognize that other and further modifications may be made thereto without departing from the spirit of the present disclosure, and it is intended to claim all such changes and modifications as fall within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

### EXAMPLE EMBODIMENTS AND IMPLEMENTATIONS

Various aspects and implementations of the present disclosure may also be appreciated from the following (enumerated) example embodiments (EEEs), which are not claims.

Example embodiments can include a method of encoding audio, performed by one or more processors. The method can include: receiving HOA audio signal including more than 4 HOA channels; encoding the HOA audio signals into waveform and metadata using SPAR quantization; and providing the encoded waveform and metadata to a downstream device, e.g., a decoder. Optionally, encoding the HOA audio signals includes selecting a SPAR quantization mode based on a bitrate limitation.

Example embodiments can include a method of decoding audio, performed by one or more processors. The method can include: receiving a bitstream; determining a SPAR quantization mode of the bitstream; and SPAR decoding the bitstream according to the quantization mode.

Example embodiments can include a method of encoding audio, performed by one or more processors. The method can include: receiving an HOA audio signal having more than 4 HOA channels in a native order, which can be ACN, but other formats are feasible as well; re-ordering the channels based on perceptual importance; SPAR downmixing a first set of at least one perceptually more important HOA channels in a first representation, and representing at least one second set of less important HOA channels in a second representation; and providing the SPAR downmixed channels to a downstream device, e.g., a decoder.

Optionally, planar HOA channels have higher priority in the ordering than non-planar HOA channels for a given Ambisonics order, whereby the planar HOA channels are assigned to the first set and the non-planar HOA channels are assigned to the second set.

Optionally, at least two HOA channels have same or equivalent positions in the ordering. The first representation can be a waveform representation. The second representation includes parameterization. In particular, the second representation includes a pruned parameterization, where certain parameters are omitted. In some implementations, a specific channel from a pair, or group, of equivalent positioned channels are selected for transmission dynamically.

Example embodiments can include a method of encoding audio and metadata, performed by one or more processors. The method can include: obtaining a bitrate limitation value for the audio and metadata; selecting a quantization mode suitable for the bitrate limitation. In various quantization modes, (a) all information in the audio and the metadata, which can be residual channels and all related metadata, can be selected; (b) at least all information in the metadata, for example parametric channels with all related metadata, can be selected; or (c) at least some coefficients are omitted, e.g., parametric channels with some related metadata selected and some related metadata omitted. The method can include SPAR downmixing the audio according to the selected quantization mode and metadata.

In some implementations, the omitted coefficients include cross-prediction coefficients. The method can include adapting at least one of the selected prediction coefficients, cross-prediction coefficients or decorrelator coefficients to compensate for the omitted coefficients.

Example embodiments can include a method of decoding audio, performed by one or more processors. The method can include: receiving encoded audio data, e.g., metadata. The audio data can include a representation of a quantization mode in which the spatial metadata is encoded. The audio data can include a bitstream, which includes the coded spatial metadata, including an indicator of which quantization mode was used, along with the audio bitstream/s.

The method can include determining padding values based on the quantization mode; inserting the padding values in place of missing SPAR metadata for decoding, the missing SPAR metadata corresponding to a particular quantization mode; and SPAR decoding the audio data based on non-missing SPAR metadata and the padding values. The padding values can include zeros or is derived from metadata of a previous frame.

EEE1. A method of encoding audio, comprising:
receiving HOA audio signal including 4 or more HOA channels;
encoding the HOA audio signals into waveform and metadata using SPAR; and
providing the encoded waveform and metadata to a downstream device.

EEE2. The method of EEE1, wherein encoding the HOA audio signals includes selecting a SPAR metadata quantization mode based on a bitrate limitation.

EEE3. A method of decoding audio, comprising:
receiving a bitstream;
determining a SPAR quantization mode of the bitstream; and
SPAR decoding the bitstream according to the quantization mode

EEE4. A method of encoding audio, comprising:
receiving an HOA audio signal having more than 4 HOA channels in a native order;
re-ordering the channels based on perceptual importance;
SPAR downmixing a first set of at least one perceptually more important HOA channels in a first representation, and representing at least one second set of less important HOA channels in a second representation; and
providing the SPAR downmixed channels to a downstream device.

EEE5. The method of EEE4, wherein planar HOA channels have higher priority in the ordering than non-planar HOA channels for a given Ambisonics order, whereby the planar HOA channels are assigned to the first set and the non-planar HOA channels are assigned to the second set.

EEE6. The method of any of EEE4 or EEE5, wherein at least two HOA channels have same or equivalent positions in the ordering.

EEE7. The method of any of EEEs 4-6, wherein the first representation is a waveform representation.

EEE8. The method of any of EEEs 4-7, wherein the second representation includes parameterization.

EEE9. The method of any of EEEs 4-8, wherein the second representation includes a pruned parameterization.

EEE10. The method of any of EEEs 4-9, wherein the downstream device is a decoder.

EEE11. The method of any of EEEs 4-10, wherein a specific channel from a pair, or group, of equivalent positioned channels are selected for transmission dynamically.

EEE12. A method of encoding audio and metadata, comprising:
obtaining a bitrate limitation value for the audio and metadata;
selecting a quantization mode suitable for the bitrate limitation, wherein, in various quantization modes,
   (a) all information in the audio and the metadata is selected;
   (b) at least all information in the metadata is selected; or
   (c) at least some coefficients are omitted; and
SPAR downmixing the audio according to the selected quantization mode and metadata.

EEE13. The method of EEE9, wherein the omitted coefficients include cross-prediction coefficients.

EEE14. The method of any of EEEs 12-13, comprising adapting at least one of the selected prediction coefficients, cross-prediction coefficients or decorrelator coefficients to compensate for the omitted coefficients.

EEE15. Method of any of EEEs 1-4, comprising computing the normalization term in the computation of one or more set of coefficients in SPAR metadata for channels corresponding to a given Ambisonics order l, by using only the covariance estimates of the channels corresponding to the order l.

EEE16. Method of any of EEEs 1-4, comprising: computation of one or more set of coefficients in SPAR metadata for parametric channels, with a first time resolution of t₁ milliseconds which is larger than the second time resolution of t₂ milliseconds of the encoder filterbank;

EEE17. Method of EEE16, wherein one or more set of coefficients in SPAR metadata are computed with second time resolution of t₂ milliseconds only for high frequency bands.

EEE18. Method of EEE17, wherein one or more set of coefficients in SPAR metadata are computed with second time resolution of t₂ milliseconds upon detection of a transient.

EEE19. A method of decoding audio data, comprising:
receiving encoded audio data including a representation of a quantization mode in which the spatial metadata is encoded;
determining padding values based on the quantization mode;
inserting the padding values in place of missing SPAR metadata for decoding, the missing SPAR metadata corresponding to a particular quantization mode; and SPAR decoding the audio data based on non-missing SPAR metadata and the
padding values.

EEE20. The method of EEE15, wherein the padding values include zeros or is derived from metadata of a previous frame.

EEE21. A system comprising:
one or more processors; and
a non-transitory computer-readable medium storing instructions that, upon execution by the one or more processors, cause the one or more processors to perform operations of any of EEEs 1-16.

EEE22. A non-transitory computer-readable medium storing instructions that, upon execution by one or more processors, cause the one or more processors to perform operations of any of EEEs 1-16.

1. A method of encoding Higher Order Ambisonics, HOA, audio, the method including:
receiving an input HOA audio signal having more than four Ambisonics channels;
encoding the HOA audio signal using a SPAR coding framework and a core audio encoder; and
providing the encoded HOA audio signal to a downstream device, the encoded HOA audio signal including core encoded SPAR downmix channels and encoded SPAR metadata.

2. The method of claim 1, wherein the encoding includes: generating, based on some or all of the Ambisonics channels, a representation of a W channel and a set of nₜₒₜₐₗ prediction residuals along with computing in SPAR metadata respective prediction coefficients; and selecting, out of the set of nₜₒₜₐₗ prediction residuals, a subset of nᵣₑₛ prediction residuals to be directly coded to obtain a number of n_{dmx}=nᵣₑₛ+1 downmix channels to be provided to the downstream device.

3. The method of claim 2, wherein the selection of the subset of nᵣₑₛ prediction residuals is based on a threshold number for directly coded channels indicating a maximum number of directly coded channels.

4. The method of claim 3, wherein the threshold number for directly coded channels is determined based on one or more of:
information indicative of one or more of a bitrate limitation, a metadata size, a core codec performance, and an audio quality; and
a predetermined set of threshold numbers for directly coded channels.

5. (canceled)

6. The method of claim 2, wherein the subset of nᵣₑₛ prediction residuals is selected in accordance with a channel ranking of the Ambisonics channels starting from high-ranked to low-ranked channels.

7. The method of claim 6, wherein the channel ranking of the Ambisonics channels is based on one or more of:
a perceptual importance of the Ambisonics channels, with Ambisonics channels being higher in the channel ranking having higher perceptual importance;
a channel ranking agreement between encoder and decoder; and
spherical harmonics Yₗ^{m}(θ, φ) of a given order l forms a subset of the channel ranking of the Ambisonics channels corresponding to spherical harmonics Yₗ₊₁^{m}(θ, φ) of an (l+1)-th order, the channel ranking of the Ambisonics channel of the (l+1)-th order staring with the channel ranking of the Ambisonics channels of the l^{th} order.

8. (canceled)

9. The method of claim 7, wherein Ambisonics channels corresponding to one or more of:
a spherical harmonic Yₗ^{m}(θ, φ) with larger overlap with a left-right-front-rear plane are ranked to be perceptually more important than Ambisonics channels corresponding to a spherical harmonic Yₗ^{m}(θ, φ) with larger overlap with a height direction, for a given order l;
a spherical harmonic Yₗ^{m}(θ, φ) with larger overlap with a left-right direction are ranked to have higher perceptual importance than Ambisonics channels corresponding to a spherical harmonic Yₗ^{m}(θ, φ) with larger overlap with a front-rear direction; and
a spherical harmonic Yₗ^{m}(θ, φ) with larger overlap in the left-right-front-rear plane of a given order l are ranked to have higher perceptual importance than Ambisonics channels corresponding to a spherical harmonic Yₗ₋₁^{m}(θ, φ) of an (l−1)-th order with larger overlap in the height direction.

10. (canceled)

11. The method of claim 7, wherein pairs formed by Ambisonics channels corresponding to spherical harmonics Yₗ^{m}(θ, φ) for a given order l with |m|=l are ranked to be perceptually more important than HOA channels for the given order l with |m|<l.

12. (canceled)

13. (canceled)

14. The method of claim 7, wherein one or more prediction residuals to be subsequently added to the subset of nᵣₑₛ prediction residuals are selected based on a ranking promoting Ambisonics channels corresponding to a spherical harmonic; Yₗ^{±l}(θ, φ) over Ambisonics channels corresponding to a spherical harmonic Yₗ^{θ}(θ, φ) ahead of Ambisonics channels corresponding to a spherical harmonic Yₗ^{m} (θ, φ), where 0<|m|<l.

15. The method of claim 2, wherein the encoding further includes representing parametric channels based on computing in SPAR metadata respective coefficients from the remaining n_{dec}=nₜₒₜₐₗ−nᵣₑₛ prediction residuals.

16. The method of claim 15, wherein the computing in SPAR metadata includes one or more of:
computing a plurality of cross-prediction coefficients for use by a decoder to reconstruct at least part of the n_{dec} parametric channels from the nᵣₑₛ directly coded prediction residuals;
computing a plurality of decorrelator coefficients for use by the decoder to account, during reconstruction, for remaining energy not accounted for by the prediction coefficients and the cross-prediction coefficients; and
computing at least one of the prediction coefficients, the cross-prediction coefficients and the decorrelator coefficients with a first time resolution of t₁ milliseconds which is larger than a second time resolution of t₂ milliseconds of an encoder filterbank.

17. (canceled)

18. (canceled)

19. The method of claim 16, wherein the computing with the second time resolution of t₂ milliseconds is only performed for high frequency bands; and optionally performed upon detection of a transient.

20. (canceled)

21. The method of claim 15, wherein the computing in SPAR metadata further includes computing a normalization term for channels corresponding to a given Ambisonics order l, by using only covariance estimates of channels corresponding to the order l.

22. The method of claim 15, wherein the encoding further includes obtaining a bitrate limitation value, selecting, out of a set of SPAR quantization modes, a SPAR quantization mode to meet the bitrate limitation value and applying the selected SPAR quantization mode to the SPAR metadata.

23. The method of claim 22, wherein some or all of the modes in the set of SPAR quantization modes include re-allocating bits to coefficients relating to Ambisonics channels being ranked higher in the channel ranking from coefficients relating to Ambisonics channels being ranked lower in the channel ranking.

24. The method of claim 22, wherein the computing in SPAR metadata includes one or more of:
computing a plurality of cross-prediction coefficients for use by a decoder to reconstruct at least part of the n_{dec} parametric channels from the nᵣₑₛ directly coded prediction residuals;
computing a plurality of decorrelator coefficients for use by the decoder to account, during reconstruction, for remaining energy not accounted for by the prediction coefficients and the cross-prediction coefficients; and
computing at least one of the prediction coefficients, the cross-prediction coefficients and the decorrelator coefficients with a first time resolution of t₁ milliseconds which is larger than a second time resolution of t₂ milliseconds of an encoder filterbank; and
wherein some or all of the modes in the set of SPAR quantization modes include one or more of:
selecting a subset of cross-prediction coefficients to be omitted from the plurality of cross-prediction coefficients;
selecting a subset of decorrelator coefficients to be omitted from the plurality of decorrelator coefficients; and
wherein selectin, the subset of coefficients is based on the channel ranking of the Ambisonics channels.

25. (canceled)

26. (canceled)

27. The method of claim 7, wherein the received input HOA audio signal consists of Ambisonics channels that are ranked to have a relatively high perceptual importance.

28. (canceled)

29. (canceled)

30. (canceled)

31. (canceled)

32. (canceled)

33. (canceled)

34. (canceled)

35. An apparatus including memory and one or more processor configured to perform the method according to claim 1.

36. (canceled)

37. A program comprising instructions that, when executed by one or more processors, cause the one or more processor, to carry out the method according to claim 1.

38. A non-transitory computer-readable storage medium storing instructions that, when executed by one or more processors, cause the one or more processors to perform the operations of claim 1.
